(19) United States
(12) Patent Application Publication
(10) Pub. No.: US 2011/0026261 A1
(43) Pub. Date: Feb. 3, 2011

(54) SEMICONDUCTOR SOLID ILLUMINATOR AND THE METHOD THEREOF

(76) Inventor: Hsinning Kuan, Taipei County (TW)

Correspondence Address: Muncy, Geissler, Olds & Lowe, PLLC, 4000 Legato Road, Suite 310, FAIRFAX, VA, 22033, US

(21) Appl. No.: 12/921,703

(22) PCT Filed: Mar. 13, 2008
(86) PCT No.: PCT/CN08/00493

§ 371 Date: Sep. 9, 2010

(51) Int. Cl. F21V 29/00

(52) U.S. Cl. 362/294

(57) ABSTRACT

A semiconductor solid illuminator and such lighting method are disclosed. The semiconductor solid illuminator of the present invention comprises a heat-dissipating body, at least an illuminant and a lamp shade. The heat-dissipating body has a conjoint surface. The illuminant is disposed on top of the conjoint surface. The lamp shade is fitted on top of the heat-dissipating body. A reflecting layer is provided on the inner surface of the lamp shade. Bright light emitted from the illuminant is reflected by the reflecting layer of the lamp shade and then travels downwards so that such light is mellowed or softened and would not shine on our eyes directly.

### BACKGROUND OF THE INVENTION

1. Field of the Invention

The invention generally relates to a semiconductor solid illuminator. More particularly, the invention relates to a semiconductor solid illuminator in which bright light emitted from the illuminant is reflected by the reflecting layer of the lamp shade and then travels downwards so that such light is mellowed and would not shine on our eyes directly.

2. Description of the Prior Art

LED and OLED, which can emit bright light, are characterized with long service life and high energy efficiency and are compact, durable, suitable for mass-production and highly responsive. They have been used in illuminators. However, they have the following disadvantages:
(1) In the prior art, bright light emitted from LED or OLED is used for illumination and such bright light is too bright and can dazzle us.
(2) In the prior art, heat is first transferred to a portion above the LED or OLED and then to several heat-dissipating fins, from which heat is dissipated into the air. Many undesirable factors (such as the accumulation of dusts and birds' droppings) may impede the heat-dissipating effect and may even damage the illuminator.

From the above, we can see that the illuminator of the prior art has many disadvantages and needs to be improved.

To eliminate the disadvantages in the prior art, the inventor has put a lot of effort into the subject and has successfully come up with the semiconductor solid illuminator of the present invention.

### SUMMARY OF THE INVENTION

An object of the present invention is to provide a semiconductor solid illuminator in which bright light emitted from the illuminant is reflected by the reflecting layer of the lamp shade and then travels downwards so that such light is mellowed or softened and would not shine on our eyes directly.

Another object of the present invention is to provide a semiconductor solid illuminator in which, because the heat-dissipating body is disposed below the illuminant, such design can enhance the heat-dissipating effect due to the fact that cooler air may quickly rise up to fill the void or vacuum created by the hotter air, which continuously travels upwards, and can bypass the undesirable factors (such as the accumulation of dusts) that may impede the heat-dissipating effect.

To reach these objects, the semiconductor solid illuminator and such method of the present invention are disclosed. The semiconductor solid illuminator of the present invention comprises a heat-dissipating body, at least an illuminant and a lamp shade. The heat-dissipating body has a conjoint surface. The illuminant is disposed on top of the conjoint surface. A plurality of heat-dissipating fins extend from the edge or lower surface of the heat-dissipating body. The lamp shade is fitted on top of the heat-dissipating body. A reflecting layer is provided on the inner surface of the lamp shade by the ordinary coating method or electroplating. Bright light emitted from the illuminant is reflected by the reflecting layer of the lamp shade and then travels downwards so that such light is mellowed or softened and would not shine on our eyes directly. In addition, heat generated by the illuminant is transferred to the heat-dissipating body and then to the heat-dissipating fins, through which the heat is dissipated into the air. Therefore, heat may be dissipated quickly. Because the heat-dissipating body is disposed below the illuminant, such design can enhance the heat-dissipating effect due to the fact that cooler air may quickly rise up to fill the void created by the hotter air, which continuously travels upwards, and can bypass the undesirable factors (such as the accumulation of dusts) that may impede the heat-dissipating effect.

Moreover, a heat-conducting body is provided in the heat-dissipating body so that heat may be transferred to the lamp shade more quickly and so as to quickly dissipate the heat.

### BRIEF DESCRIPTION OF THE DRAWINGS

FIG. 1 is a perspective view showing the semiconductor solid illuminator of the present invention with the lamp shade detached from the rest of the semiconductor solid illuminator.

FIG. 2 is a view showing the semiconductor solid illuminator of the present invention in an assembled condition.

FIG. 3 is a sectional view showing the semiconductor solid illuminator of the present invention in an assembled condition.

FIG. 4 is a sectional view showing the semiconductor solid illuminator of the present invention in operation.

FIG. 5 is a view showing the second embodiment of the present invention.

FIG. 6 is a sectional view showing the third embodiment of the present invention.

### DETAILED DESCRIPTION OF THE PREFERRED EMBODIMENTS

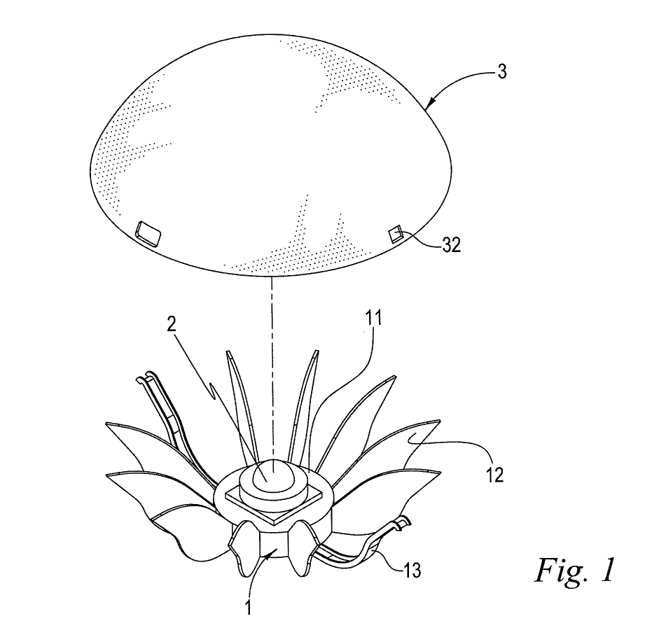

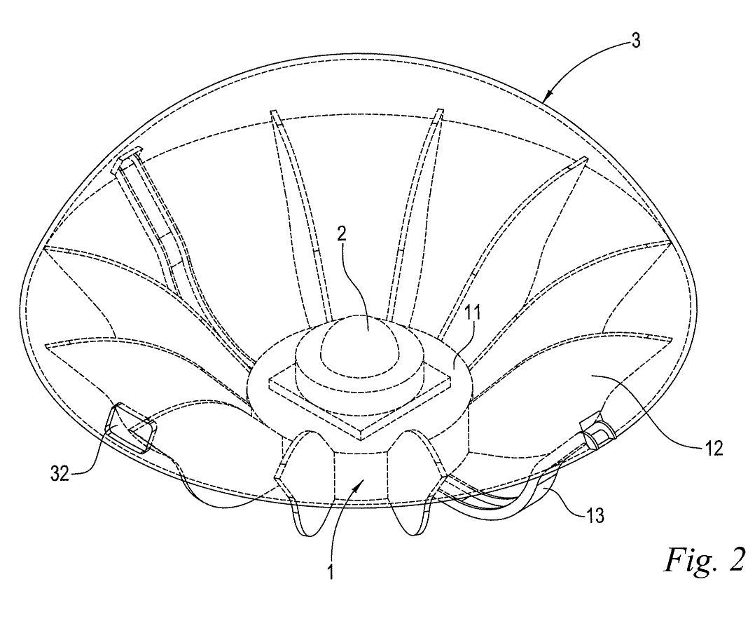

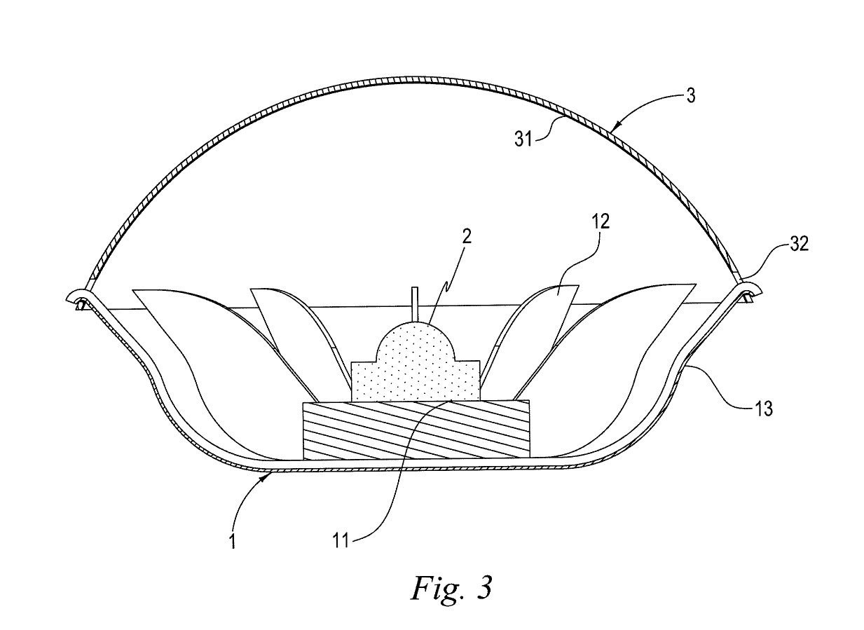

Please see FIGS. 1, 2 and 3. The semiconductor solid illuminator of the present invention comprises a heat-dissipating body 1, at least an illuminant 2 and a lamp shade 3. The heat-dissipating body 1 has a conjoint surface 11. A plurality of heat-dissipating fins 12 extend from the edge or lower surface of the heat-dissipating body 1. An electric wire slot 13 is provided in the heat-dissipating body 1 to hold an electric wire. The electric wire slot 13 may be integrally formed with the heat-dissipating fins 12. The illuminant 2 is fitted on top of the conjoint surface 11. The illuminant 2 is an LED or an OLED. A reflecting layer 31 is provided on the inner surface of the lamp shade 3 and a plurality of holes 32 are provided in the peripheral body of the lamp shade 3. In assembly, the lamp shade 3 is fitted on top of the heat-dissipating body 1 so as to cover the illuminant 2. The lamp shade 3 is connected with the heat-dissipating body 1 through the engagement of the electric wire slot 13 or the heat-dissipating fins 12 and the holes 32. In addition, the holes 32 also act as the vents to assist the heat dissipation. Furthermore, the reflecting layer 31 is provided on the inner surface of the lamp shade 3 by the ordinary coating method or electroplating. Moreover, the reflecting layer 31 may be a metallic layer or a glass layer provided on the inner surface of the lamp shade 3.

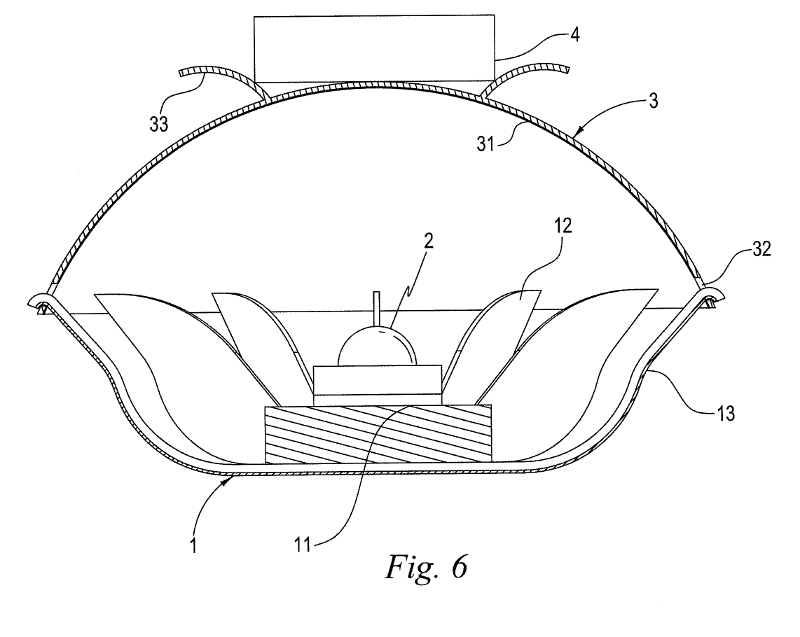

An electric wire connects the illuminant 2 with a power supply 6 (please see FIG. 6) to supply electricity to the illuminant 2. Also, the electric wire is disposed in the electric wire slot 13 to embellish the appearance. The lamp shade 3 may be connected with the heat-dissipating body 1 in many forms and all of these forms should be included in the scope of the invention.

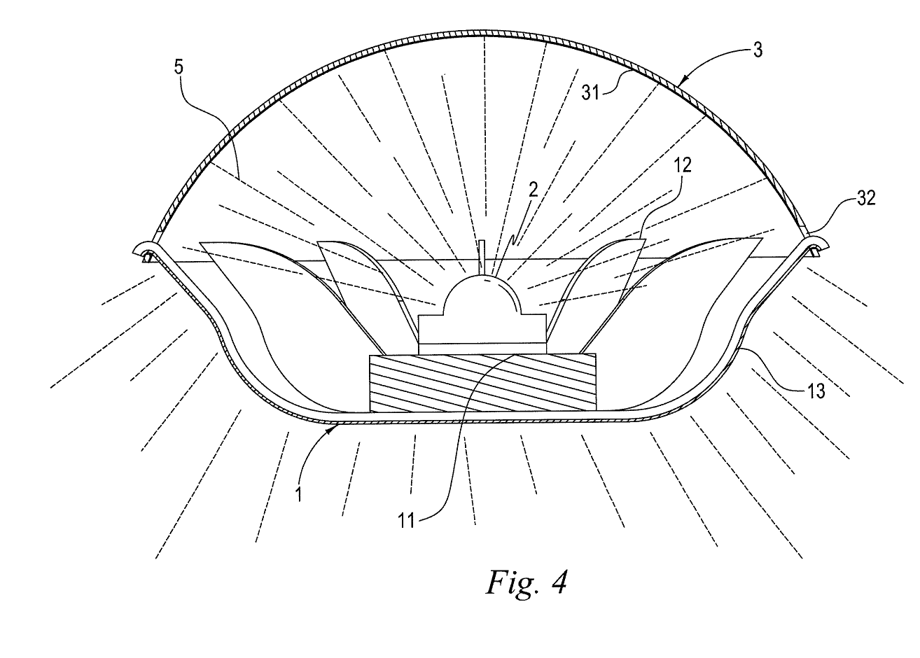

Please see FIG. 4, which is a view showing the semiconductor solid illuminator of the present invention in operation. When the illuminant 2 is lit, the illuminant 2 emits bright light 5, which is then reflected by the reflecting layer 31 of the lamp shade 3 and travels downwards. Therefore, such light is mellowed and would not shine on our eyes directly. In addition, heat generated by the illuminant 2 is transferred to the heat-dissipating body 1 and then to the heat-dissipating fins 12, through which the heat is dissipated into the air. Also, the heat-dissipating fins 12 can further mellow out the light.

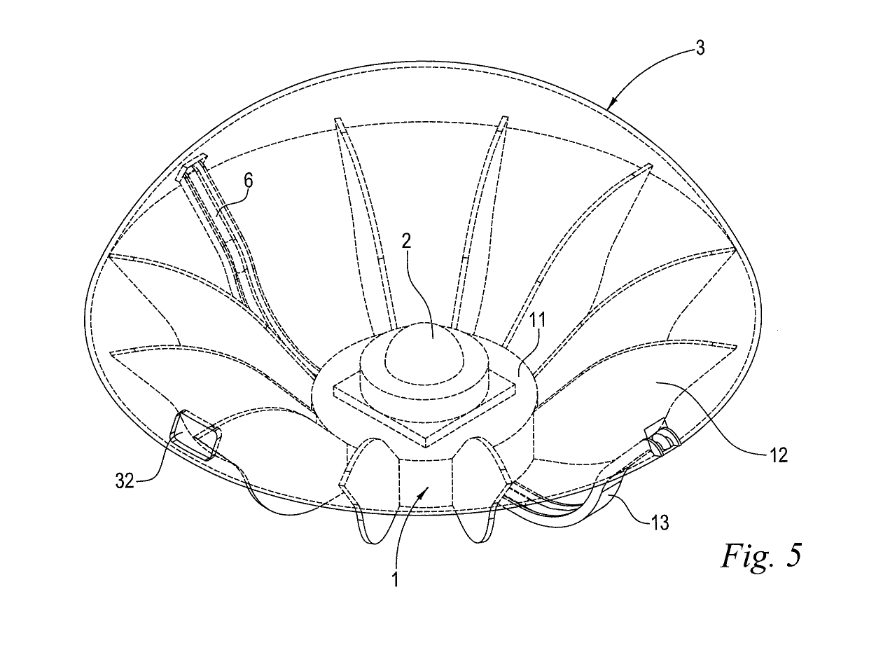

Now, please see FIG. 5, which is a view showing the second embodiment of the present invention. In the second embodiment, a heat-conducting body 6 is disposed in the electric wire slot 13. The inner end of the heat-conducting body 6 is connected with the heat-dissipating body 1 and the outer end of the heat-conducting body 6 is connected with the lamp shade 3 or a heat-dissipating module to quickly dissipate the heat.

Please see FIG. 6, which is a view showing the third embodiment of the present invention. In the third embodiment, the lamp shade 3 is made of a heat-dissipating material. After the lamp shade 3 is fitted on top of the heat-dissipating body 1, the lamp shade 3 would be in contact with the heat-dissipating fins 12 so that heat may be transferred from the heat-dissipating fins 12 to the lamp shade 3 and then be dissipated from the lamp shade 3 into the air.

Two fins 33 that extend from the top body of the lamp shade 3 may be provided to hold a power supply 4. Therefore, heat generated by the power supply 4 may be transferred to the lamp shade 3 and then be dissipated from the lamp shade 3 into the air.

In comparison to the prior art, the semiconductor solid illuminator of the present invention has the following advantages:
1. In the semiconductor solid illuminator of the present invention, bright light emitted from the illuminant is reflected by the reflecting layer of the lamp shade and then travels downwards. Therefore, such light is mellowed and would not shine on our eyes directly.
2. In the semiconductor solid illuminator of the present invention, because the heat-dissipating body is disposed below the illuminant 2, such design can enhance the heat-dissipating effect due to the fact that cooler air may quickly rise up to fill the vacuum created by the hotter air, which continuously travels upwards.

Although several preferred embodiments of the present invention have been described in detail hereinabove, it should be understood that the preferred embodiments are to be regarded in an illustrative manner rather than a restrictive manner, and all variations and modifications of the basic inventive concepts herein taught still fall within the scope of the present invention.

What is claimed is:

1. A semiconductor solid illuminator, comprising:
a heat-dissipating body, having has a conjoint surface;
at least an illuminant, disposed on top of the conjoint surface, wherein the light emitted by the illuminant travels upwards; and
a lamp shade, wherein a reflecting layer is provided on the inner surface of the lamp shade and the lamp shade is fitted on top of the heat-dissipating body,
characterized in that bright light emitted from the illuminant is reflected by the reflecting layer of the lamp shade and then travels downwards.

2. The semiconductor solid illuminator as in claim 1, wherein a plurality of heat-dissipating fins extend from the edge or lower surface of the heat-dissipating body to increase the heat-dissipating speed of the heat-dissipating body.

3. The semiconductor solid illuminator as in claim 1, wherein an electric wire slot is provided in the heat-dissipating body to hold an electric wire.

4. The semiconductor solid illuminator as in claim 3, wherein a heat-conducting body is disposed in the electric wire slot, and wherein the inner end of the heat-conducting body is connected with the heat-dissipating body and the outer end of the heat-conducting body is connected with the lamp shade or a heat-dissipating module to quickly dissipate the heat.

5. The semiconductor solid illuminator as in claim 1, wherein the illuminant is an LED or an OLED.

6. The semiconductor solid illuminator as in claim 1, wherein a plurality of holes are provided in the peripheral body of the lamp shade and the lamp shade is connected with the heat-dissipating body through the engagement of the electric wire slot or the heat-dissipating fins and the holes.

7. The semiconductor solid illuminator as in claim 1, wherein the reflecting layer is provided on the inner surface of the lamp shade by the ordinary coating method or electroplating.

8. The semiconductor solid illuminator as in claim 1, wherein the reflecting layer of the lamp shade may be a metallic layer or a glass layer provided on the inner surface of the lamp shade.

9. The semiconductor solid illuminator as in claim 1, wherein an electric wire connects the illuminant with a power supply to supply electricity to the illuminant.

10. A semiconductor solid illuminator, comprising:
a heat-dissipating body, having has a conjoint surface;
at least an illuminant, disposed on top of the conjoint surface, wherein the light emitted by the illuminant travels upwards; and
a lamp shade, wherein a reflecting layer is provided on the inner surface of the lamp shade and two heat-dissipating fins extend from the outer surface of the lamp shade, and wherein the lamp shade is fitted on top of the heat-dissipating body,
characterized in that bright light emitted from the illuminant is reflected by the reflecting layer of the lamp shade and then travels downwards.

11. The semiconductor solid illuminator as in claim 10, wherein a plurality of heat-dissipating fins extend from the edge or lower surface of the heat-dissipating body to increase the heat-dissipating speed of the heat-dissipating body.

12. The semiconductor solid illuminator as in claim 10, wherein an electric wire slot is provided in the heat-dissipating body to hold an electric wire.

13. The semiconductor solid illuminator as in claim 12, wherein a heat-conducting body is disposed in the electric wire slot, and wherein the inner end of the heat-conducting body is connected with the heat-dissipating body and the outer end of the heat-conducting body is connected with the lamp shade or a heat-dissipating module to quickly dissipate the heat.

14. The semiconductor solid illuminator as in claim 10, wherein the illuminant is an LED or an OLED.

15. The semiconductor solid illuminator as in claim 10, wherein a plurality of holes are provided in the peripheral body of the lamp shade and the lamp shade is connected with the heat-dissipating body through the engagement of the electric wire slot or the heat-dissipating fins and the holes.

16. The semiconductor solid illuminator as in claim 10, wherein the reflecting layer is provided on the inner surface of the lamp shade by the ordinary coating method.

17. The semiconductor solid illuminator as in claim 10, wherein the reflecting layer of the lamp shade may be a metallic layer or a glass layer provided on the inner surface of the lamp shade.

18. The semiconductor solid illuminator as in claim 10, wherein an electric wire connects the illuminant with a power supply to supply electricity to the illuminant.

19. A lighting method, comprising:
at least an illuminant;
a heat-dissipating body, wherein the illuminant is disposed on top of the heat-dissipating body; and
a lamp shade, with a reflecting layer,
characterized in that bright light emitted from the illuminant is reflected by the reflecting layer of the lamp shade and then travels downwards so that such light is mellowed and would not shine on our eyes directly.

20. The method as in claim 19, wherein a plurality of heat-dissipating fins extend from the edge or lower surface of the heat-dissipating body and can further mellow out the light.
